(19) United States
(12) Patent Application Publication
(10) Pub. No.: US 2002/0074844 A1
(43) Pub. Date: Jun. 20, 2002

(54) Adjustable armrest

(76) Inventors: Michael Klingstedt, Falkoping (SE); Arne Ekbom, Slutarp (SE)

Correspondence Address: SMITH, GAMBRELL & RUSSELL, LLP, SUITE 800, 1850 M STREET, N.W., WASHINGTON, DC, 20036, US

(21) Appl. No.: 10/015,897

(22) Filed: Dec. 17, 2001

(30) Foreign Application Priority Data
Dec. 18, 2000 (SE) 0004675-5

(51) Int. Cl. B60N 2/46; A47C 7/54

(52) U.S. Cl. 297/411.31

(57) ABSTRACT

An armrest (1) for a work chair is adjustable in the vertical and longitudinal directions. Moreover, the armrest (1) is pivotal in a substantially horizontal plane about a pivot axis (13) which is disposed in a rear end region of the armrest (1). The armrest (1) is disposed on a rail (6) longitudinal in relation to the longitudinal axis of the armrest (1) in the lower region (5) of the armrest (1). The rail (6) is pivotally connected to the armrest (1) in the pivot axis (13). The rail (6) is further displaceable along its length in relation to a pedestal (2) which supports the armrest (1).

### TECHNICAL FIELD

The present invention relates to an armrest for a work chair, the armrest being adjustable in the vertical direction and the longitudinal direction.

### BACKGROUND ART

A long time ago, chairs in general, but also work chairs, were manufactured as fixed units without any possibility of individual adjustment. With the passage of time, it was realised that there was a need for adjustability, since human bodies are very different as regards both length, weight and also the bodily parts' mutual size and differences in different peoples' muscular strength.

From having been adjustable in sitting height and backrest height, work chairs have developed into being adjustable in an increasing number of respects. It is now possible to adjust sitting well depth, the angle of the seat, possibility to rock the chair, the height of the armrest, etc. In recent years, multiple strain syndrome injuries caused as a result of monotonous and/or incorrect working positions have been increasingly focussed on, and the need for improved chair ergonomics has moved centre stage.

After seating and backrest support having attracted the greatest interest, there is now growing recognition of the importance of the armrest for a correct working position. Just as the seat and backrest are adjustable, there is also a need to be able to adjust the armrest in numerous different respects.

One such respect is adjustability in the longitudinal direction, which may be realised in that the armrests are reversible. In this instance, the armrest has one side which projects a relatively long distance while the other side is shorter. In order to realise a switch between projecting armrest and armrest in the rear position, respectively, the armrest must be removed and reversed. This is quite a complex operation and the risk is imminent that the user carry out this adjustment only once, i.e. when the chair is new. If the chair is used by several people, there is a manifest risk that the adjustment of the armrest will be incorrect for many of them.

One and the same user may also have a need for different length adjustments of the armrest for different working duties. When the user needs to sit close to a table edge, the far projecting armrest has a tendency to collide with the edge of the table. The result may then be that the user will have a working position which is unsuitable not only for the arms and shoulders, but which also places stress on the back. A few examples of working duties which require different adjustment positions of both seat and backrest, as well as armrest are work at computers using a mouse or other pointer device, keyboard work such as word processing or programming, reading or handwriting at writing desks, telephone conversations and conversations with a person present in the same room. In all of these situations, the body—and thereby the arms—assumes a number of different positions.

U.S. Pat. No. 5,407,249 discloses a work chair which displays adjustable armrests. The construction disclosed is quite complex and has many regulatory devices and adjustment wheels which must be operated to alter the position of the armrests. By experience, it is clearly known that the more complicated the adjustment of a chair is, the more seldom will its various positions be changed. The consequence will rather be that the user adapts to the chair instead of the reverse. The above-mentioned Patent Specification shows armrests which are pivotal in one plane, but in addition to this pivotal feature being difficult to adjust, the armrest suffers from the drawback that the pivotal point is placed centrally beneath the armrest. This placing entails that the elbow is moved away from the body when the front edges of the armrest are moved towards one another. A working position in which the elbow is far from the body often has a negative effect on muscles in both the upper arm and the back and shoulders.

### Problem Structure

The object of the present invention is to realise armrests which are simply adjustable to ergonomically suitable positions for different users so that the whole of the forearm can obtain support in different working duties.

### Solution

The object forming the basis of present invention will be attained if the armrest intimated by way of introduction is characterised in that the armrest is pivotal in a substantially horizontal plane about a pivot axis which is disposed in a rear end region of the armrest.

Further advantages will be attained if the armrest is moreover given one or more of the characterising features as set forth in appended claims 2 to 8.

### BRIEF DESCRIPTION OF THE ACCOMPANYING DRAWINGS

The present invention will now be described in greater detail hereinbelow, with reference to the accompanying Drawings. In the accompanying Drawings:

FIG. 1 is a straight side elevation of an armrest according to the invention where this is located in a retracted position;

FIG. 2 is a view corresponding to that of FIG. 1 when the armrest is located in a protracted position;

FIG. 3 is a view straight from beneath of the armrest when this is located in a position which corresponds to a maximum pivoting in the one direction, as well as an intermediate position in the longitudinal direction; and

FIG. 4 is a view corresponding to that of FIG. 3, but with a portion of a front edge cut away when the armrest is located in the second side position, at the same time as it assumes an intermediate position in the longitudinal direction.

### DESCRIPTION OF PREFERRED EMBODIMENT

In the following description, an armrest for a chair, such as a work chair, will be described. The Drawings and positions that are then disclosed, for instance up, down, forward, rear, relate to directions and positions in relation to how a user normally sits in the chair.

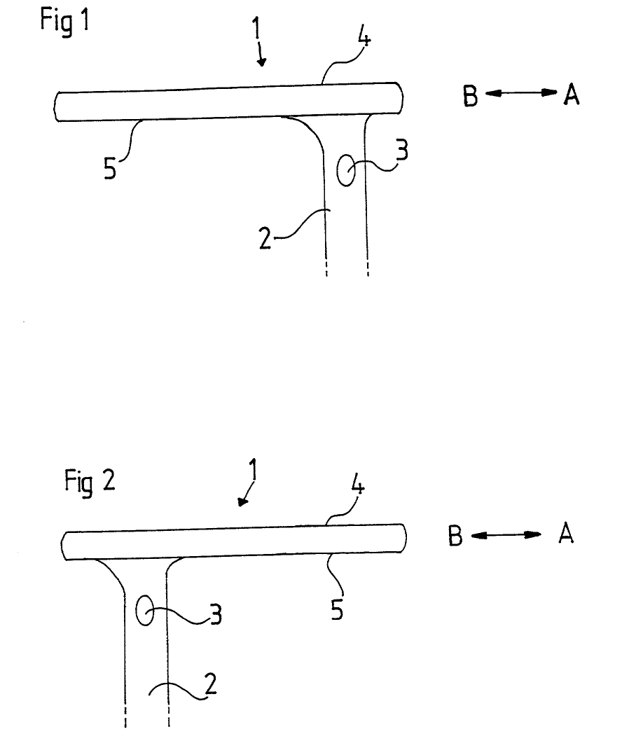

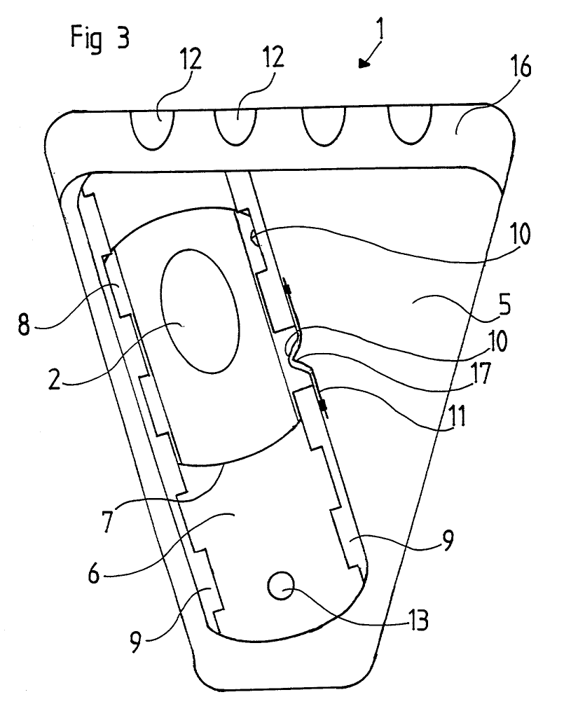

A chair has armrests 1 which are illustrated in FIGS. 1 and 2 and which are disposed at each side of the chair, each on its pedestal 2. The armrests 1 are movable in relation to each respective pedestal 2 in a direction forwards and rearwards on the chair, in accordance with the double-headed arrow A-B, where A designates forwards and B designates rearwards. On forward movement A and rearward movement B, the armrest is located substantially in one and the same plane which is largely horizontal.

In addition to being movable forwards and rearwards, the armrests 1 may be angled. By this is taken to signify that the front ends of the armrests are movable towards and away from a user sitting in the chair, while the rear ends of the armrests 1 are located in substantially the same position during the angling movement. The rear ends are however movable on movement forwards and rearwards. That the rear end retains its position affords the advantage that the user may obtain support for the whole of the forearm without the elbow needing to be rotated out away from the user's body.

The armrest 1 has an upper side 4 which is advantageously provided with some form of soft padding or upholstery. The under side 5 of the armrest is connected to the pedestal 2. This connection is realised in the preferred embodiment by means of a rail 6 which is disposed between the pedestal 2 and the under side 5 of the armrest 1.

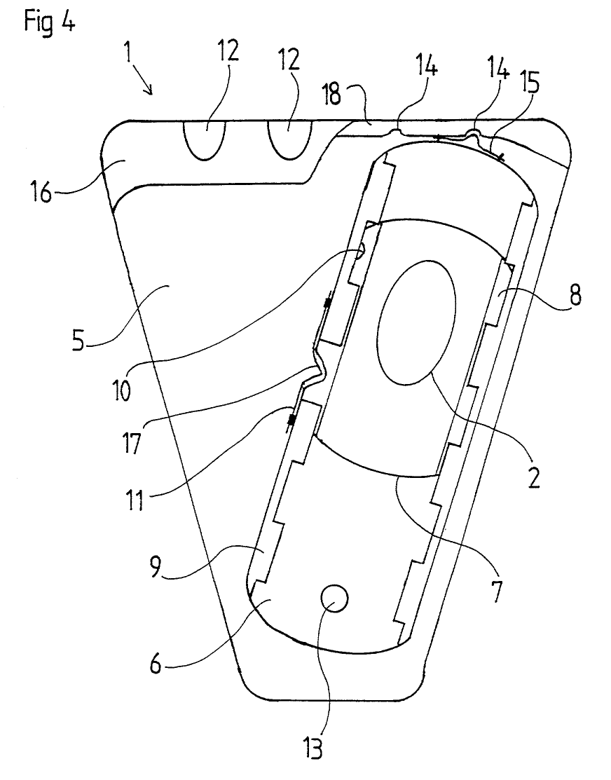

The under side 5 of the armrest 1, which advantageously manufactured from hard plastic, is interconnected with the rail 6 by the intermediary of a pin 13 in the rear end of the rail. The under side 5 is best visible in FIGS. 3 and 4. At the front end of the rail 6 and the armrest 1, the under side 5 of the armrest 1 is interconnected with the rail by a projecting edge 16 which extends out under a front region of the under side of the rail 6. Thus, the rail 6 is reciprocal in a groove-shaped space which is upwardly defined by the under side 5 and downwardly by the upper side of the projecting edge 16. The interconnection 18 which forwardly unites the under side 5 and the edge 16 is suitably of arcuate configuration seen from beneath or above, the centre of arc being the pivot axis or pin 13.

The rail 6 is in turn connected to the pedestal 2. This is made possible in the preferred embodiment in that the upper region of the pedestal 2 is designed as a platform 7 with opposing, substantially mutually parallel edges. The platform 7 thus has a substantially planar surface whose width is substantially equal to the width of the rail 6. The platform 7 of the pedestal 2 has, along its two sides, a projecting edge or flange 8 which, as will disclosed in greater detail below, serves the function of a slip- or sliding guide together with corresponding means on the rail 6.

Along its side edges, the rail 6 is provided with inwardly folded lugs or flaps 9 which are bent in over the rail in such a manner that there is an interspace between the flaps 9 and the rail 6. The interspace is substantially the same size as or slightly larger in the vertical direction than the height of the flanges 8. Consequently, the pedestal 2 is movable forwards and rearwards along the rail 6 in such a manner that the platform 7 of the pedestal abuts against the under side of the rail 6 and its flanges 8 are overlapped on their under side by the flaps 9. It will thereby be realised that the armrest 1 is, by means of above-mentioned slip- or sliding guide, movable forwards and rearwards in accordance with the double-headed arrow A-B.

In the preferred embodiment, the armrest is provided with a number of distinct arrest positions for its movement forwards and rearwards. The arrest positions are such that one user may use the chair in a normal way without displacing the armrests 1, while if a slightly increased force is applied by the user, the armrests 1 may nevertheless be moved out of their current arrest position to another position.

In order to realise the different positions and ensure that the armrest is retained in these positions until such time as the user wishes to change position, a number of recesses 10 are provided in at least one of the projecting edges or flanges 8 on the platform 7 of the pedestal 2. A spring 11 is disposed at the side of the rail 6 corresponding to that side of the platform 7 of the pedestal 2 where the recesses 10 are provided.

The spring 11 may be disposed on the outside of the rail 6 and project in over this through a recess in its upwardly folded edge, or be disposed inside the upwardly folded edge and wholly or partly covered by the inwardly folded lugs or flaps 9. Regardless of how the spring 11 is placed, it is provided with a protruding projection 17 which snaps into one of the recesses 10 when these are located in register with the projection 17. If the armrest is, with a force which exceeds the forces which occur on normal use, shifted forwards or rearwards, the projection 17 of the spring 11 is dislodged from its position in any of the recesses 10 and the armrest is then movable to another position which is represented by another recess 10. By such means, a plurality of distinct positions may be provided for the armrest 1 when this is slid forwards or rearwards.

In order to facilitate the movement of the armrest forwards or rearwards, and in order that the user “instinctively” and simply be able to adjust his or her sitting position, finger grips 12 are disposed on the under side of the projecting edge 16 in the forward end of the armrest. The finger grips 12 which may most closely be described as a number of cup-shaped recesses, preferably four in number for the fingers will make it easier for the user to understand how the hands are ideally placed on movement of the armrest.

As was mentioned earlier, the armrest 1 can, in addition to being moved in its longitudinal direction, also be angled outwards and inwards in relation to the user, at the same time as the armrest 1 is substantially horizontal and its rear end is moved minimally. It is thus the forward end of the armrest 1 which moves in a direction towards or away from the user. In order to achieve this, the rail 6 is pivotal in relation to the armrest 1. As was described above, the rail 6 is connected to the under side 5 of the armrest by the intermediary of the pin 13 and the projecting edge 16 in the forward end of the armrest. A portion of this edge 16 has been cut away in FIG. 4. The pivotability or angling function, is achieved in that the rail 6 may be pivoted about the pin 13 in relation to the armrest 1. It is also possible to invert this reasoning and assert that the armrest 1 may be pivoted about the pin 13 in relation to the rail 6.

Since the pin 13 is located in the rear end of the rail 6 and the armrest 1, this implies that the greatest displacement will be obtained in the armrest 1 in its forward end. The large displacement entails that the user's forearms will be given good support regardless of whether the wrists are to be held close to the body or be angled away from it. In each position, the elbows can be kept close to the body.

As in the displacement in the longitudinal direction, it is occasionally desirable that the armrest can be turned to one or more different positions between the end positions. In order to realise distinct positions, recesses 14 are provided inside the projecting edge 16, provided with the finger grips 12, in the forward end of the armrest 1. The end positions each have their recess 14, and each desired intermediate position is represented by one recess 14 each. In a manner corresponding to the longitudinal displacement of the armrest 1, a spring 15 is provided in the forward edge of the rail. The armrest 1 is moved between the different snap engagements, which correspond to the different positions, in that an extra force is applied to the armrest 1. The finger grips 12 can also advantageously be used on turning of the armrest 1.

### DESCRIPTION OF ALTERNATIVE EMBODIMENTS

Without appreciably deviating from the inventive concept as herein disclosed, modifications may be made to the above-described invention. This principally applies to the realisation of the different distinct positions. If desired, the springs 11, 15 of the snap engagements may be caused to change places with the recesses 10, 14. The function will then be substantially the same, but the manufacturing processes will be somewhat different.

In the foregoing, no major consideration was paid to how the pedestals 2 are secured to the chair, or whether they are movable in relation to it. In such instance, there is considerable freedom to design the chair, at the same time as the above-described armrests are employed.

The present invention may be modified further without departing from the scope of the appended claims.

What is claimed is:

1. An armrest for a work chair, the armrest (1) being adjustable in the vertical direction and the longitudinal direction, characterised in that the armrest (1) is pivotal in a substantially horizontal plane about a pivot axis (13) which is disposed in a rear end region of the armrest (1).

2. The armrest as claimed in claim 1, characterised in that the armrest (1) is disposed on a rail (6) longitudinal in relation to the longitudinal axis of the armrest, in the lower region (5) of the armrest (1); and that the rail (6) is pivotally connected to the armrest (1) in the pivot axis (13).

3. The armrest as claimed in claim 2, characterised in that the rail (6) is displaceable throughout its length in relation to a pedestal (2) which supports the armrest (1).

4. The armrest as claimed in any of claims 2 or 3, characterised in that the armrest (1) is pivotal to at least one distinct position between the end positions.

5. The armrest as claimed in any of claims 2 or 3, characterised in that the armrest (1) is pivotal between the two end positions.

6. The armrest as claimed in any of claims 4 or 5, characterised in that a spring (15) is provided between the rail (6) and a forward region of the armrest (1); and that the spring (15) is movable to snap engagement in recesses (14) either in the rail (6) or in the armrest (1).

7. The armrest as claimed in claim 3, characterised in that the rail (6) is displaceable to at least one distinct position between the end positions.

8. The armrest as claimed in claim 7, characterised in that the rail (6) is provided with a spring (11) which is disposed for snap engagement in at least one recess (10) in the pedestal (2) or vice versa.

9. The armrest as claimed in any of claims 2 to 8, characterised in that the rail (6) has undercut grooves along its edges, in which projections or flanges (8) projecting in opposing directions on the end region (7) of the pedestal (2) are displaceable in the longitudinal direction of the rail (6) or vice versa.
